(19) United States
(12) Patent Application Publication
(10) Pub. No.: US 2025/0330710 A1
(43) Pub. Date: Oct. 23, 2025

(54) IMAGING APPARATUS

(71) Applicant: CANON KABUSHIKI KAISHA, Tokyo (JP)

(72) Inventors: KEISUKE FUKUYO, Tokyo (JP); SHIMPEI ISHIKAWA, Kanagawa (JP)

(21) Appl. No.: 19/176,895

(22) Filed: Apr. 11, 2025

(30) Foreign Application Priority Data
Apr. 19, 2024 (JP) 2024-068178
Mar. 31, 2025 (JP) 2025-059093

(51) Int. Cl. H04N 23/68; G03B 5/00; H04N 23/54; H04N 23/55

(52) U.S. Cl. CPC H04N 23/687; G03B 5/00; H04N 23/54; H04N 23/55; G03B 2205/0015; G03B 2205/0038; G03B 2205/0069

(57) ABSTRACT

In an imaging apparatus, a fixing member disposed on a main body of the imaging apparatus, a magnet held by the fixing member, an imaging element, a first movable member that holds the imaging element and is movable with respect to the fixing member in a direction orthogonal to an optical axis of the imaging element; and a coil held by the first movable member and disposed at a position facing the magnet are provided. A part of the fixing member is located at a position interposed between the imaging element and the first movable member in a direction of the optical axis, and a part of the coil is located so as to overlap with the imaging element on a projection plane perpendicular to the optical axis.

### BACKGROUND OF THE INVENTION

### Field of the Invention

The present invention relates to an imaging apparatus.

### Description of the Related Art

Conventionally, an image blur correction apparatus that moves a movable part having an imaging element in a parallel to a fixing part has been widely used. In the blur correction apparatus, the movable part is driven so as to cancel a blur based on a blur detection amount detected by a blur detection unit.

As a configuration of a driving force generation unit in the image blur correction device, there is a configuration that is referred to as a voice coil motor (VCM) system. In this configuration, either the movable part is provided with a magnet and the fixing part is provided with a coil, or the movable part is provided with a coil and the fixing part is provided with a magnet, and a driving force is generated by energizing the coil in a magnetic circuit formed by the magnet. Additionally, a plurality of balls is disposed between the movable part and the fixing part, and the movable part is attracted to the fixing part side by an biasing unit such as a spring or a magnet.

In the configuration using the VCM, in order to maintain the imaging element at an appropriate position, it is necessary to hold the movable part by continuously generating a driving force through coil energization. Therefore, compared to an imaging apparatus that does not have an image blur correction mechanism, power consumption increases, which may lead to a decrease in the number of photos the camera can take. Additionally, in this configuration, because the VCM is disposed outside the imaging element, the size of the image blur correction mechanism along a plane perpendicular to the optical axis increases, making camera miniaturization difficult.

In Japanese Patent Application Laid-Open No. 2016-170339, a fixing part in which a plurality of coils are arranged, and a movable part including a plurality of magnets arranged to face the plurality of coils and an imaging element are provided, and the magnets are attached to the movable part in such a manner that the magnets overlap with the imaging element on a projection plane perpendicular to the optical axis of the light incident on the imaging element.

However, in the conventional technology disclosed in Japanese Patent Application Laid-Open No. 2016-170339, because the movable part must be provided with heavy yoke members and magnets in addition to the imaging element, driving power must be increased in order to maintain the imaging element at an appropriate position.

### SUMMARY OF THE INVENTION

In order to achieve the above object, an imaging apparatus according to one aspect of the present invention comprises a fixing member disposed on a main body of the imaging apparatus; a magnet held by the fixing member; an imaging element; a first movable member that holds the imaging element and is movable with respect to the fixing member in a direction orthogonal to an optical axis of the imaging element; and a that is coil held by the first movable member and is disposed at a position facing the magnet, wherein a part of the fixing member is disposed at a position interposed between the imaging element and the first movable member in a direction of the optical axis, and wherein a part of the coil is disposed so as to overlap with the imaging element on a projection plane perpendicular to the optical axis.

Further features of the present invention will become apparent from the following description of embodiments with reference to the attached drawings.

### BRIEF DESCRIPTION OF THE DRAWINGS

FIG. 1 is a diagram explaining a schematic configuration example of an imaging apparatus according to the First Embodiment of the present invention.

FIG. 2A is an exploded perspective view of a first blur correction unit 40 provided in the imaging apparatus according to the First Embodiment.

FIG. 2B is an exploded perspective view of the first image blur correction unit 40 viewed from a direction different from that in FIG. 2A.

FIG. 3A is an exploded perspective view of a fixing part 20 of the first blur correction unit 40.

FIG. 3B is an exploded perspective view of the fixing part 20 of the first blur correction unit 40 viewed from a direction different from that in FIG. 3A.

FIG. 4A is an exploded perspective view of a movable part 30 of the first blur correction unit 40.

FIG. 4B is an exploded perspective view of the movable part 30 viewed from a direction different from that in FIG. 4A.

FIG. 5A is a front view of the first blur correction unit 40.

FIG. 5B is a cross-sectional view of the first blur correction unit 40 taken along line A-A.

FIG. 6 is a projection view showing a relation between a magnet and an imaging element of a blur correction unit according to the First Embodiment.

FIG. 7A is an exploded perspective view of the first blur correction unit 40 provided in the imaging apparatus according to the Second Embodiment.

FIG. 7B is an exploded perspective view of the first blur correction unit 40 viewed from a direction different from that in FIG. 7A.

FIG. 8A is an exploded perspective view of the fixing part 20 of the first blur correction unit 40 according to the Second Embodiment.

FIG. 8B is an exploded perspective view of the fixing part 20 of the first blur correction unit 40 viewed from a direction different from that in FIG. 8A.

FIG. 9A is an exploded perspective view of the movable part 30 of the first blur correction unit 40 according to the Second Embodiment.

FIG. 9B is an exploded perspective view of the movable part 30 of the first blur correction unit 40 viewed from a direction different from that in FIG. 9A.

FIG. 10A is a front view of the first blur correction unit 40 according to the Second Embodiment.

FIG. 10B is a cross-sectional view of the first blur correction unit 40 according to the Second Embodiment, taken along line B-B.

FIG. 11A is an exploded perspective view of the first blur correction unit 40 provided in the imaging apparatus according to the Third Embodiment.

FIG. 11B is an exploded perspective view of the first blur correction unit 40 viewed from a direction different from that in FIG. 11A.

FIG. 12A is an exploded perspective view of the first blur correction unit 40 provided in the imaging apparatus according to the Fourth Embodiment.

FIG. 12B is an exploded perspective view of the first blur correction unit 40 viewed from a direction different from that in FIG. 12A.

FIG. 13A is an exploded perspective view of the first blur correction unit 40 provided in the imaging apparatus according to the Fifth Embodiment.

FIG. 13B is an exploded perspective view of the first blur correction unit 40 viewed from a direction different from that in FIG. 13A.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### FIRST EMBODIMENT

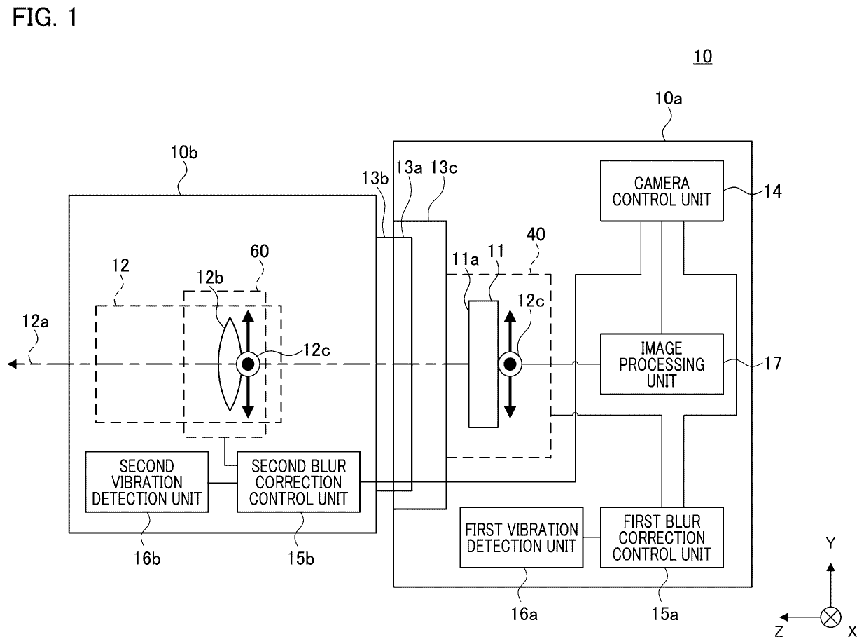

FIG. 1 is a diagram explaining an example of a schematic configuration of an imaging apparatus 10 according to the First Embodiment of the present invention. Note that some of the functional blocks as shown in FIG. 1 are realized by causing a CPU and the like that serve as a computer (not illustrated) included in the imaging apparatus 10 to execute a computer program stored in a memory that serves as a storage medium (not illustrated).

However, some or all of the functional blocks may be realized by hardware. As hardware, a dedicated circuit (ASIC), a processor (reconfigurable processor, DSP), and the like can be used. Additionally, each functional block as shown in FIG. 1 need not be incorporated in the same housing, and may be configured by separate devices that are connected to each other via a signal path.

The imaging apparatus 10 is, for example, referred to as a mirrorless digital camera, and has a main body 10a of the imaging apparatus and a lens barrel 10b that is attachable to and detachable from the main body 10a of the imaging apparatus.

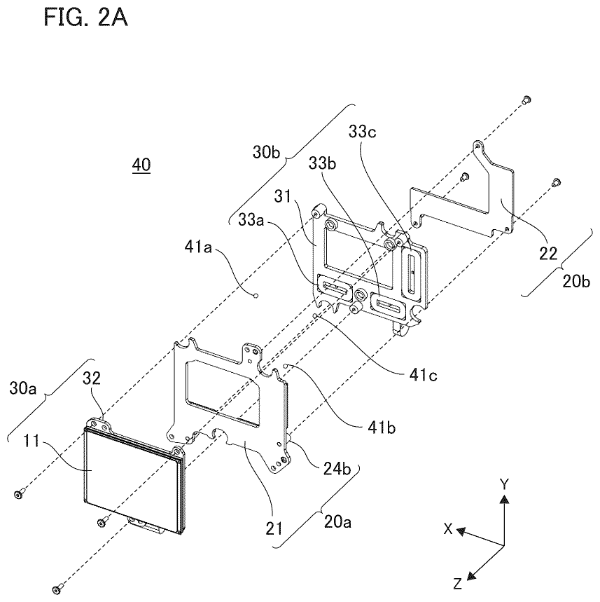

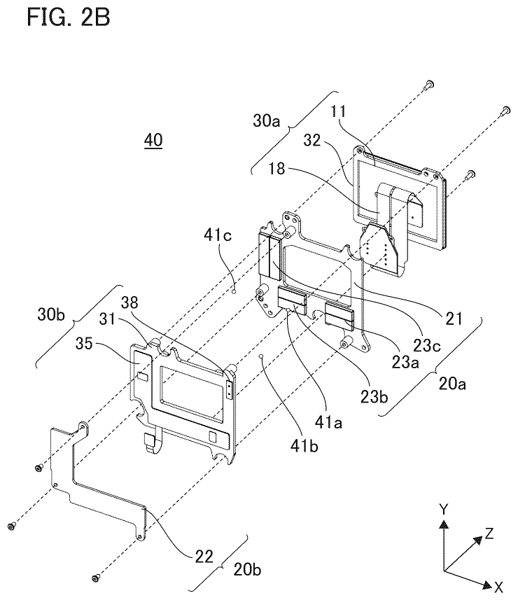

The main body 10a includes an imaging element 11 having an imaging surface 11a, an imaging FPC 18 (See FIG. 2B), a base member 13c, a main body-side mount member 13a, a camera control unit 14, a first blur correction control unit 15a, a first vibration detection unit 16a, an image processing unit 17, and a first blur correction unit 40. Note that FPC is an abbreviation for flexible printed circuit.

Additionally, the lens barrel 10b is provided with an imaging optical system 12 that includes a blur correction lens 12b, a lens-side mount member 13b, a second blur correction control unit 15b, a second vibration detection unit 16b, and a second blur correction unit 60.

In the present embodiment, a virtual light ray that serves as a representative of a light flux irradiated to the imaging surface 11a of the imaging element 11 via the imaging optical system 12 is referred to as an optical axis 12a, and a plane orthogonal to the optical axis 12a is referred to as an optical axis orthogonal plane 12c.

The optical axis 12a passes through the center of the imaging surface 11a and is orthogonal to the imaging surface 11a. Additionally, as shown in FIG. 1, an X direction, a Y direction, and a Z direction, that are orthogonal to each other, are defined to clarify the arrangement and positional relation between each unit that configures the imaging apparatus 10 within the imaging apparatus 10. The Z direction is a direction parallel to the optical axis 12a, the X direction is a widthwise direction of the imaging apparatus 10, and the Y direction is a height direction of the imaging apparatus 10. The optical axis orthogonal plane 12c is the XY plane.

The imaging element 11 is configured by photoelectric conversion elements such as a CMOS image sensor and a CCD image sensor, and is disposed in such a manner that the imaging surface 11a of the imaging element 11 faces the subject side (lens barrel 10b side) so that the imaging surface 11a is orthogonal to the optical axis 12a. The imaging element 11 generates an image signal by photoelectrically converting an optical image of a subject formed on the imaging surface 11a by the imaging optical system 12.

The image signal generated by the imaging element 11 is transmitted to the image processing unit 17 via the imaging FPC 18. The image processing unit 17 performs various processing to convert the image signal into image data, and the image data is stored in a memory (storage device) (not illustrated).

The camera control unit 14 is a calculation unit in a main IC (not illustrated), receives an input operation from a user via an operation unit (not illustrated), and controls the overall operation of the imaging apparatus 10. Note that the camera control unit 14 includes a built-in CPU that serves as a computer, and performs control of each unit of the imaging apparatus 10 by executing a computer program stored in a memory (not illustrated).

The imaging optical system 12 is configured by a lens group (not illustrated) disposed inside the lens barrel 10b and forms an image of light from a subject (not illustrated) on the imaging surface 11a of the imaging element 11. In the imaging apparatus 10, in order to position the imaging element 11 with high accuracy relative to the optical axis 12a, the imaging element 11 is attached to the base member 13c that is provided in the main body 10a, and furthermore, the lens barrel 10b is also connected to the base member 13c.

The imaging element 11 is attached to the base member 13c via the first blur correction unit 40. Additionally, the lens barrel 10b is connected to the base member 13c via the lens-side mount member 13b and the main body-side mount member 13a.

The first blur correction unit 40 moves the imaging element 11 in the XY direction or rotates the imaging element 11 within the XY plane, thereby correcting an image blur caused by a shake occurring in the imaging apparatus 10 and enabling obtaining of a clear subject image.

Specifically, when the orientation of the imaging apparatus 10 changes with respect to the subject during imaging, the imaging position of the subject light flux on the imaging surface 11a of the imaging element 11 changes, and thus blurring occurs in the image obtained through the imaging element 11.

At this time, in a case in which the orientation change of the imaging apparatus 10 is sufficiently small, change in the imaging position is uniform within the imaging surface 11a, and the change in the imaging position can be regarded as translation or rotational movement (image plane blur) within the XY plane. Therefore, by translating or rotating the imaging element 11 within the XY plane so as to cancel this image plane blur, a clear subject image in which image blur has been corrected can be obtained.

Note that a configuration may be adopted in which the imaging element 11 performs movement in the Z direction during performing translational movement or rotational movement within the XY plane. Similarly, the second blur correction unit 60 enables obtaining a clear subject image by performing correction of image blur caused by shake occurring in the imaging apparatus 10 by moving the blur correction lens 12b in the XY direction.

That is, the optical axis 12a is refracted by moving the blur correction lens 12b in the XY plane direction. At this time, the blur correction lens 12b is moved in the XY plane direction so as to cancel the image plane blur. Consequently, a clear subject image in which image blur has been corrected can be obtained. Note that because the principles of blur correction by moving the imaging element 11 and the blur correction lens 12b are known, a more detailed explanation thereof will be omitted.

Note that a configuration in which movement in the Z direction is also performed when the blur correction lens 12b is moved in the XY plane direction may be adopted. The first blur correction unit 40 includes a fixing part, a movable part, and a plurality of driving force generation units. The fixing part is fixed to the base member 13c, and the movable part holds the imaging element 11.

The movable part is supported by the fixing part having three degrees of freedom, and can be moved in the XY direction or rotated in the XY plane relative to the fixing part. That is, the first blur correction unit 40 is configured as a drive device that enables drive control on three axes (referred to as an XY θ stage), and can move the imaging element 11 in the XY directions and rotate the imaging element 11 within the XY plane.

The second blur correction unit 60 includes a fixing part, a movable part, and a plurality of driving force generation units. The fixing part is fixed to a housing (not illustrated) of the lens barrel 10b, and the movable part holds the blur correction lens 12b. The movable part is supported by the fixing part with two degrees of freedom and can move in the XY direction relative to the fixing part.

That is, the second blur correction unit 60 is configured as a driving device that can be controlled to be driven on two axes (referred to as the XY stage) wherein the second blur correction unit 60 enables movement of the blur correction lens 12b in the XY direction.

Each of the first vibration detection unit 16a and the second vibration detection unit 16b are blur detection units that are configured by gyro sensors or acceleration sensors, and detect angular velocity or acceleration in each direction of the imaging apparatus 10 as blur information of the imaging apparatus 10.

The first blur correction control unit 15a calculates angle variation amounts and movement amounts in each direction of the imaging apparatus 10 as blur information by integrating the angular velocity or acceleration detected by the first vibration detection unit 16a, and the second blur correction control unit 15b calculates angle variation amounts and movement amounts in each direction of the imaging apparatus 10 as blur information by integrating the angular velocity or acceleration detected by the second vibration detection unit 16b.

Furthermore, the first blur correction control unit 15a calculates a movement target value of the imaging element 11 based on blur information detected by the first vibration detection unit 16a, and controls movement of the imaging element 11 by controlling driving of the first blur correction unit 40.

Similarly, the second blur correction control unit 15b calculates a movement target value of the blur correction lens 12b based on blur information detected by the second vibration detection unit 16b, and controls movement of the blur correction lens 12b by controlling the driving of the second blur correction unit 60. Note that the imaging apparatus 10 may be configured to include only one of the first blur correction unit 40 and the second blur correction unit 60.

In a case in which the first blur correction unit 40 is not provided, the imaging element 11 is disposed fixedly with respect to the optical axis 12a. In a case in which the second blur correction unit 60 is not provided, the blur correction lens 12b is basically unnecessary. In this case, the imaging optical system 12 of the lens barrel 10b is designed so as to obtain desired optical characteristics using a lens configuration that does not include the blur correction lens 12b.

Next, a detailed configuration of the first blur correction unit 40 will be explained. Note that because the configuration of the second blur correction unit 60 is known, an explanation thereof is omitted.

FIG. 2A is an exploded perspective view of the first blur correction unit 40 that is provided in the imaging apparatus according to the First Embodiment, and FIG. 2B is an exploded perspective view of the first blur correction unit 40 viewed from a direction different from that in FIG. 2A.

The first blur correction unit 40 is configured by a fixing part 20, the movable part 30, and balls 41a to 41c. The fixing part 20 is configured by a front fixing part 20a and a rear fixing part 20b. The movable part 30 is configured by a front movable part 30a and a rear movable part 30b.

In the first blur correction unit 40, the front movable part 30a, the front fixing part 20a, the rear movable part 30b, and the rear fixing part 20b are disposed in order of proximity to the mount member 13a on the body side in the Z direction.

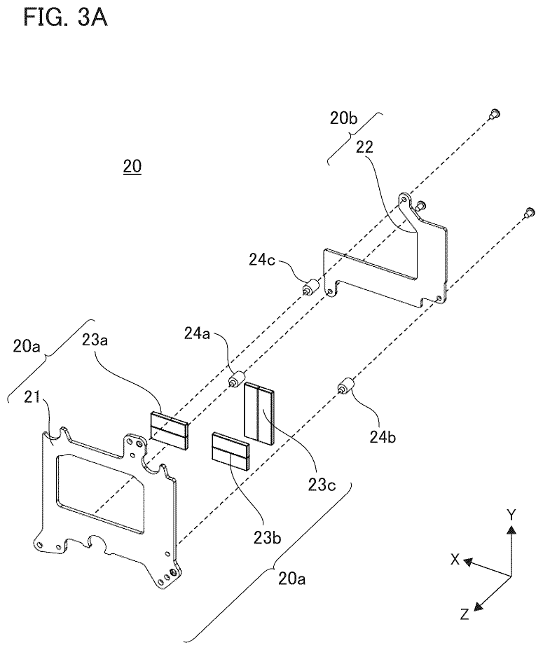

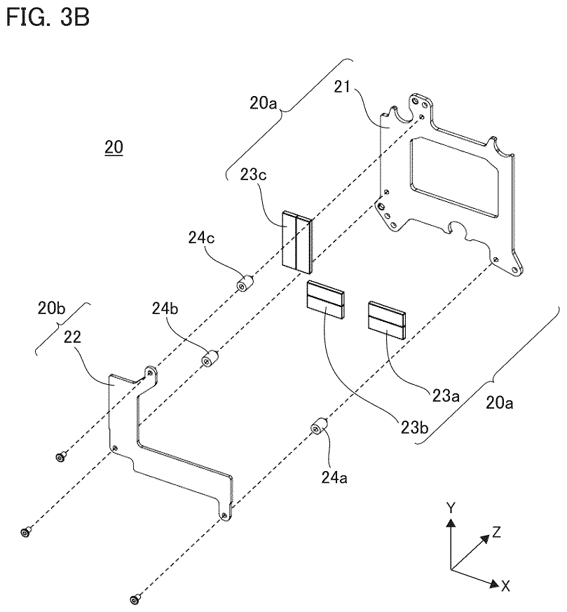

FIG. 3A is an exploded perspective view of the fixing part 20 of the first image blur correction unit 40, and FIG. 3B is an exploded perspective view of the fixing part 20 of the first image blur correction unit 40 viewed from a direction different from FIG. 3A.

The front fixing part 20a includes a base plate 21, a first front magnet group 23a, a second front magnet group 23b, and a third front magnet group 23c. Here, the base plate 21 functions as a fixing member disposed inside the main body 10a of the imaging apparatus.

Each of the first front magnet group 23a, the second front magnet group 23b, and the third front magnet group 23c is held by being fixed to the base plate 21 that serves as a fixing member using an adhesive and the like. Additionally, the base plate 21 that serves as a fixing member is formed of magnetic material. The rear fixing part 20b includes a rear yoke 22.

In the present embodiment, the first front magnet group 23a, the second front magnet group 23b, and the third front magnet group 23c are arranged side by side in such a manner that two magnets, each magnetized in the Z direction, generate magnetic fields in opposite directions. However, the present invention is not limited thereto, and one magnet magnetized to two poles may be used.

The fixing part 20 also includes a first support column member 24a, a second support column member 24b, and a third support column member 24c. The rear yoke 22 of the rear fixing part 20b is fixed to the base plate 21 of the front fixing part 20a via the first support column member 24a, the second support column member 24b, and the third support column member 24c by screws and the like.

Additionally, the first support column member 24a, the second support column member 24b, and the third support column member 24c are disposed at positions that restrict movement of the movable part 30, and restrict movement of the movable part 30 in the XY plane within a predetermined range.

At contact points between the first support member 24a, the second support member 24b, the third support member 24c and the movable part 30, cushioning materials such as rubber are provided for absorbing impact during contact, thereby avoiding damage and reducing an impact sound.

The rear yoke 22 and the base plate 21 are disposed such that the first front magnet group 23a, the second front magnet group 23b, and the third front magnet group 23c are interposed therebetween in the Z direction. The first front magnet group 23a forms a first magnetic circuit passing through the rear yoke 22 and the base plate 21. Similarly, the second front magnet group 23b and the third front magnet group 23c form a second magnetic circuit and a third magnetic circuit.

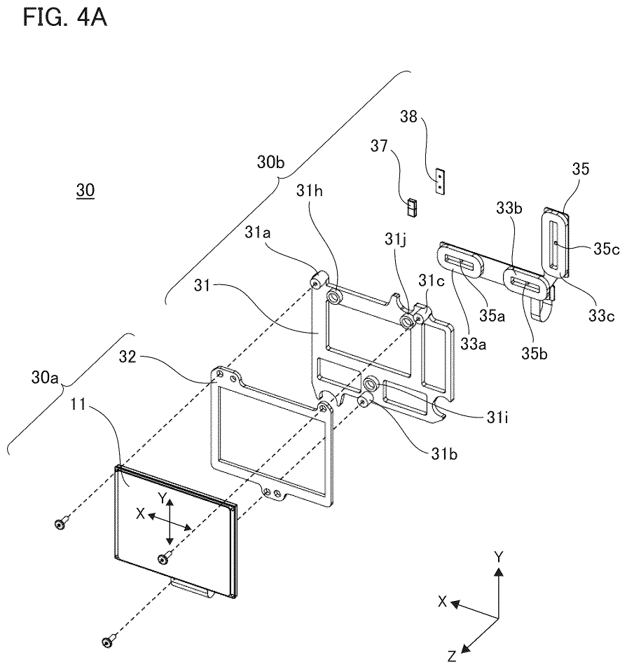

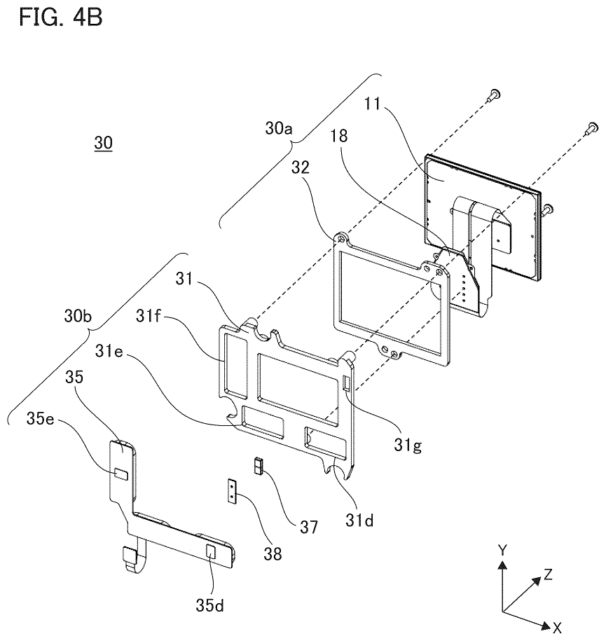

FIG. 4A is an exploded perspective view of the movable part 30 of the first blur correction unit 40 and FIG. 4B is an exploded perspective view of the movable part 30 viewed from a direction different from that in FIG. 4A.

The movable part 30 is configured by a front movable part 30a and a rear movable part 30b. The front movable part 30a includes the imaging element 11, the imaging FPC 18, and a second movable member 32, and the imaging element 11 is fixed to the second movable member 32 by adhesive and the like.

The rear movable part 30b includes a first movable member 31, a first coil 33a, a second coil 33b, a third coil 33c, a drive FPC 35, a thrust magnet 37, and a thrust yoke 38. The first movable member 31 includes a fourth support part 31a, a fifth support part 31b, and a sixth support part 31c.

The first movable member 31 holds the imaging element 11 and is movable relative to the direction orthogonal to the optical axis of the imaging element with respect to the base plate 21 that serves as a fixing member. Additionally, the first coil 33a is held by the first movable member 31 and is disposed at a position facing the first front magnet group 23a, the second coil 33b is held by the first movable member 31 and is disposed at a position facing the second front magnet group 23b, and the third coil 33c is held by the first movable member 31 and is disposed at a position facing the third front magnet group 23c.

The second movable member 32 of the front movable part 30a is fixed to the fourth support part 31a, the fifth support part 31b, and the sixth support part 31c that are formed on the first movable member 31 of the rear movable part 30b using screws and the like. That is, the second movable member 32 holds the imaging element 11 and is fixed to the first movable member 31.

Additionally, the fourth support part 31a, the fifth support part 31b, and the sixth support part 31c are disposed at positions that restrict movement of the movable part 30, and may be configured to restrict movement of the movable part 30 in the XY plane within a predetermined range.

At contact portions of the fourth support column 31a, the fifth support column 31b, and the sixth support part 31c to the fixing part 20, cushioning materials such as rubber are provided for absorbing impact during contact, and prevention of damage and reduction of impact sound are realized.

Note that the second movable member 32 is desirably formed of a material having a linear expansion coefficient larger than that of the first movable member 31. Accordingly, when the internal temperature of the imaging apparatus 10 changes, the movable part 30 deforms in the Z direction by a bimetal effect of the first movable member 31 and the second movable member 32.

Because this deformation is in a direction opposite to the deformation direction of the base member 13c, it is possible to suppress a change in the distance between the lens side mount member 13b and the imaging surface 11a. That is, it becomes possible to suppress a flange bank change when the internal temperature of the imaging apparatus 10 changes.

However, the present invention is not limited thereto, and the configuration may be such that the image capturing element 11 has a fixing part for attaching to the first movable member 31 and is directly fixed to the first movable member 31 by screws or the like. In this case, the second movable member 32 becomes unnecessary.

The drive FPC 35 is disposed so as to overlap the first coil 33a, the second coil 33b, and the third coil 33c on the XY-projection plane, and the drive FPC 35 is fixed to the first movable member 31 by adhesive and the like.

The first movable member 31 includes a first recess part 31d, a second recess part 31e, and a third recess part 31f. The first coil 33a is disposed inside the first recess part 31d, the second coil 33b is disposed inside the second recess part 31e, and the third coil 33c is disposed inside the third recess part 31f, and each coil is fixed to the first movable member 31 by adhesive and the like.

The first magnetic circuit and the first coil 33a form a VCM that serves as the first actuator, the second magnetic circuit and the second coil 33b form a VCM that serves as the second actuator, and the third magnetic circuit and the third coil 33c form a VCM that serves as the third actuator.

A Lorentz force is generated in a direction orthogonal to the magnetic field generated in the Z direction in the first magnetic circuits and the current flowing through the first coil 33a, and the resultant force direction of the Lorentz forces changes depending on the energization direction of the first coil 33a. Similar Lorentz forces are also generated between the second magnetic circuit and the second coil 33b, and between the third magnetic circuit and the third coil 33c.

The first actuator and the second actuator generate forces (driving forces) substantially parallel to the Y direction, a translational force in the Y direction is generated by the sum of the respective forces, and a rotational force around the optical axis is generated due to the difference between the forces. The third actuator generates a translational force in the X direction. The drive FPC 35 includes a first detection element 35a, a second detection element 35b, and a third detection element 35c mounted thereon.

The first detection element 35a is disposed inside the first coil 33a, the second detection element 35b is disposed inside the second coil 33b, and the third detection element 35c is disposed inside the third coil 33c.

The first detection element 35a, the second detection element 35b, and the third detection element 35c are, for example, Hall elements. The first detection element 35a detects the magnetic force of the first magnetic circuit, and based on this result, the first blur correction control unit 15a calculates the position information in the XY plane of the movable part 30 with respect to the fixing part 20 (specifically, the position and the angle around the optical axis). The same applies to the second detection element 35b and the third detection element 35c.

The first coil 33a, the second coil 33b, and the third coil 33c are electrically connected to the drive FPC 35, and the first blur correction control unit 15a controls the current flowing through each coil via the drive FPC 35.

That is, the first blur correction control unit 15a calculates a deviation between the movement target value of the imaging element 11 based on the blur information detected by the first vibration detection unit 16a and the current position of the imaging element 11 detected by the first detection element 35a to the third detection element 35c. Then, driving of the movable part 30 is controlled by feedback control based on this deviation.

The movable part 30 is supported by the base plate 21 via the balls 41a to 41c serving as rolling members to enable movement within the XY plane. The balls 41a to 41c are respectively arranged inside a first enclosure part 31h, a second enclosure part 31i, and a third enclosure part 31j provided in the first movable member 31. That is, the plurality of balls 41a to 41c serving as rolling members are disposed such that the balls contact the first movable member 31 and the base plate 21 serving as the fixing member.

When the movable part 30 moves in the XY plane relative to the fixing part 20, the balls 41a to 41c roll, therefore the load due to friction between the first movable member 31 and the base plate 21 is minimal. The first movable member 31 includes a fourth recess 31g at a position facing the base plate 21.

Each of the thrust magnet 37 and the thrust yoke 38 is fixed by adhesive or the like to the fourth recess 31g. The thrust magnet 37 forms a fourth magnetic circuit passing through the thrust yoke 38 and the base plate 21. The first movable member 31 of the movable part 30 is biased in the +Z direction toward the base plate 21 by an attraction force generated between the thrust magnet 37 and the base plate 21.

That is, the thrust magnet 37, the thrust yoke 38, and the base plate 21 configure a first biasing part that biases the movable part 30 in the +Z direction toward the fixing part 20.

Furthermore, the movable part 30 includes a first thrust metal plate 35d and a second thrust metal plate 35e. The first thrust metal plate 35d is disposed at a position facing the first front magnet group 23a, and the second thrust metal plate 35e is disposed at a position facing the third front magnet group 23c, and the first and second thrust metal plates are fixed to the drive FPC 35 by adhesive or the like.

The first thrust metal plate 35d serves as a yoke member that is held by the first movable member 31 and is disposed at a position facing the first front magnet group 23a, and the second thrust metal plate 35e serves as a yoke member that is held by the first movable member 31 and is disposed at a position facing the third front magnet group 23c.

The first thrust metal plate 35d and the second thrust metal plate 35e are formed of a magnetic body, and generate a suction force between the first front magnet group 23a and the third front magnet group 23c that face these plates.

Each of the first thrust metal plate 35d and the second thrust metal plate 35e configure a second biasing part and a third biasing part for biasing the first movable member 31 in the +Z direction toward the base plate 21 that serves as a fixing member.

That is, the first thrust metal plate 35d and the second thrust metal plate 35e that serve as yoke members bias the first movable member 31 in a direction approaching the base plate 21 by magnetic force of the first front magnet group 23a and the third front magnet group 23c.

Accordingly, it is possible to reduce the size of the rear yoke 22 in the XY plane, and by setting a lead-out direction of the drive FPC 35 to the direction opposite to the rear yoke 22 in the XY plane, it becomes possible to suppress an increase in size of the first blur correction unit 40 in the Z direction.

The first biasing part, the second biasing part, and the third biasing part are disposed such that a center of gravity of a movable part 30 is positioned inside a triangle formed by connecting each biasing part in the XY plane. The same arrangement applies to balls 41a to 41c. Accordingly, a biasing force with respect to a movable part 30 can be generated with balance. Thereby, floating of a movable part 30 during driving can be prevented.

Next, the relationship between the imaging element 11 of the first blur correction unit 40 and the first magnetic circuit, the second magnetic circuit, and the third magnetic circuit explained above will be explained.

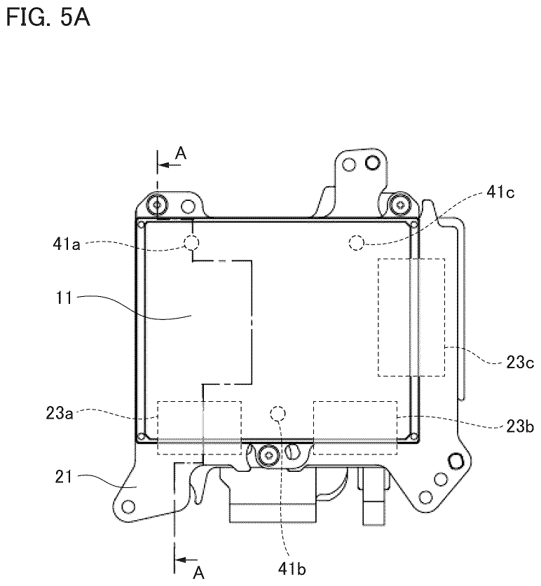

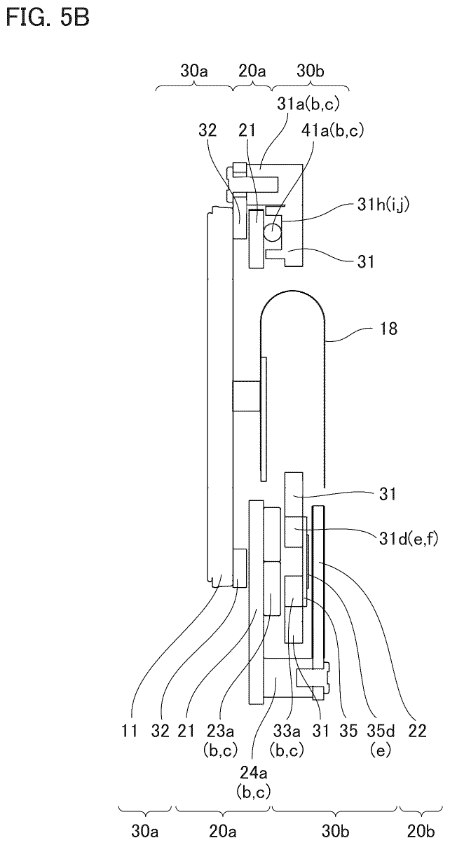

FIG. 5A is a front view of the first blur correction unit 40 and FIG. 5B is a cross-sectional view of the first image blur correction unit 40 taken along line A-A. As shown in FIG. 5B, the movable part 30 is brought into contact at the fourth support column 31a (and the fifth support column 31b, sixth support column 31c) of the first movable member 31 and the second movable member 32, and is fixed with clearance in other regions.

In addition, the fixing part 20 comprises the front fixing part 20a and the rear fixing part 20b, wherein the front fixing part 20a contacts with the first columnar member 24a, the second columnar member 24b, and the third columnar member 24c respectively, and wherein a rear fixed part 20b contacts with the first support member 24a, the second support member 24b, and the third support member 24c respectively, and wherein regions other than contact regions are fixed with clearance.

As shown in FIG. 5B, in the cross section near the first magnetic circuit, the front movable part 30a (the imaging element 11 and the second movable member 32) is disposed with clearance in order from the +Z direction to the −Z direction.

Subsequently, in the −Z direction, the front fixing part 20a (the base plate 21 and the first front magnet group 23a), the rear movable part 30b (the first movable member 31, and the drive FPC 35 having the first coil 33a) are disposed in this order with a clearance. Subsequently, the rear fixing part 20b (rear yoke 22) is disposed with a clearance in the −Z direction. The second magnetic circuit and the third magnetic circuit are disposed similarly to the first magnetic circuit.

Additionally, in the cross section of the support part (near the ball 41a) of the movable part 30 and the fixed part 20, the front movable part 30a (the imaging element 11 and the second movable member 32) and the front fixing part 20a (the base plate 21) are disposed in order from the +Z direction to the −Z direction.

Subsequently, the ball 41a and the rear movable part 30b (first movable member 31) are arranged in the −Z direction. The movable part 30 and the fixing part 20 are similarly arranged in other parts (the vicinity of the ball 41b and the ball 41c).

As described above, in the present embodiment, a part of the base plate 21 that serves as the fixing member is disposed at a position interposed between the imaging element 11 and the first movable member 31 in the optical axis direction (Z direction).

Additionally, the first front magnet group 23a, the second front magnet group 23b, and the third front magnet group 23c are disposed at positions interposed between the imaging element 11 and the first movable member 31 in the optical axis direction (Z direction).

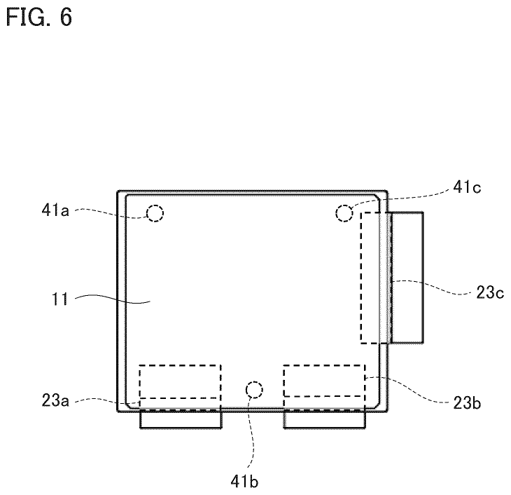

FIG. 6 is a projection view showing a relation between an imaging element and a magnet of the blur correction unit according to First Embodiment. That is, FIG. 6 is a projected view showing the imaging element 11, the first front magnet group 23a, the second front magnet group 23b, the third front magnet group 23c, and the balls 41a to 41c in FIG. 5B.

In addition, as shown in FIG. 6, the first front magnet group 23a, the second front magnet group 23b, the third front magnet group 23c, and the balls 41a to 41c are disposed such that at least a part thereof overlaps with the image capturing element 11 on the XY projection plane.

That is, a part of the first front magnet group 23a, the second front magnet group 23b, and the third front magnet group 23c is disposed so as to overlap with the imaging element 11 on the projection plane.

In addition, a part of the first coil 33a, the second coil 33b, and the third coil 33c is disposed to overlap with the image capturing element 11 on a projection plane perpendicular to the optical axis. In addition, at least a part of the balls 41a to 41c serving as rolling members is disposed so as to overlap with the imaging element 11 on the XY projection plane.

As described above, in the blur correction device of the present embodiment, the first front magnet group 23a, the second front magnet group 23b, and the third front magnet group 23c are not disposed on the movable part 30. Moreover, it becomes possible to dispose the first front magnet group 23a, the second front magnet group 23b, and the third front magnet group 23c so as to partially overlap with the imaging element 11 on the projected plane of the optical axis 12a.

Thereby, it becomes possible to reduce the size of the first blur correction unit 40 without increasing the weight of the movable part 30 of the first blur correction unit 40 (that is, without increasing the drive power).

### SECOND EMBODIMENT

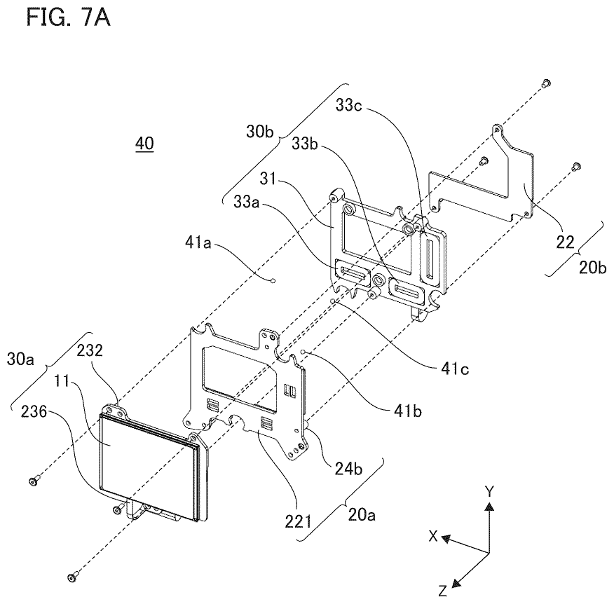

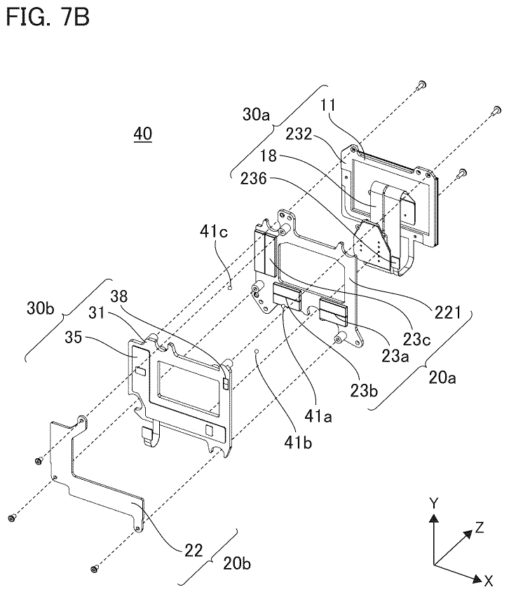

Hereinafter, with reference to FIG. 7 to FIG. 10, a more desirable arrangement of the position detection unit for detecting a position of the movable part 30 in the first blur correction unit 40 of the image capturing apparatus 10 according to the Second Embodiment of the present invention will be explained. Because aspects other than the position detection unit of the movable part 30 are similar to the First Embodiment, an explanation thereof will be omitted.

FIG. 7A is an exploded perspective view of the first blur correction unit 40 that is provided in the imaging apparatus according to the Second Embodiment, and FIG. 7B is an exploded perspective view of the first blur correction unit 40 viewed from a direction different from that in FIG. 7A.

The first blur correction unit 40 is configured by the fixing part 20, the movable part 30, and balls 41a to 41c. The fixing part 20 is configured by the front fixing part 20a and the rear fixing part 20b.

The movable part 30 is configured by a front movable part 30a and a rear movable part 30b. In the first blur correction unit 40, the front movable part 30a, the front fixing part 20a, the rear movable part 30b, and the rear fixing part 20b are disposed in order of proximity to the mount member 13a on the body side in the Z direction.

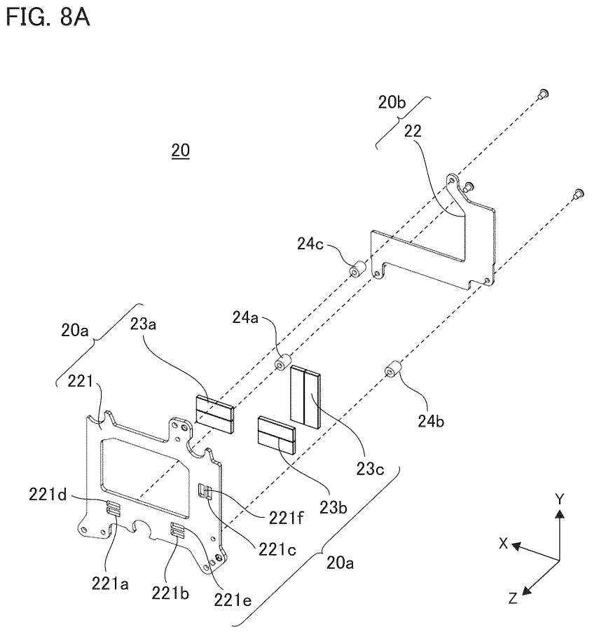

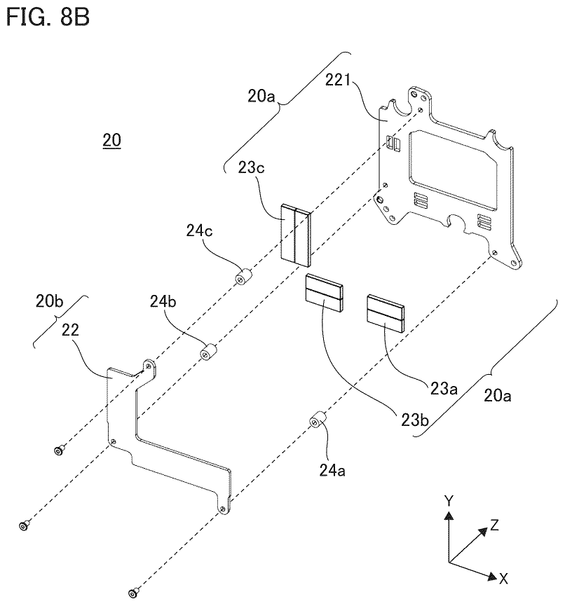

FIG. 8A is an exploded perspective view of the fixing part 20 of the first blur correction unit 40, and FIG. 8B is an exploded perspective view of the fixing part 20 of the first image blur correction unit 40 viewed from a direction different from that in FIG. 8A.

The base plate 221 has a first opening 221a, a second opening 221b, and a third opening 221c, wherein the first opening 221a is disposed at a position facing the first front magnet group 23a, wherein the second opening 221b is disposed at a position facing the second front magnet group 23b, and wherein the third opening 221c is disposed at a position facing the third front magnet group 23c.

The first opening 221a is larger than the movement amount of the first movable member 31 in a direction orthogonal to the optical axis. Additionally, the first opening 221a has a first beam part 221d at a position that coincides with the boundary surface of the N pole and the S pole on the XY projection plane of the first front magnet group 23a.

The second opening 221b has a second beam part 221e and the third opening 221c has a third beam part 221f, and the size of the opening and the position of the rib are similar to those of the first opening 221a. That is, the first opening 221a to the third opening 221c have the first bead part 221d to the third beam part 221f at positions corresponding to the boundary surfaces of the N pole and the S pole of the first front magnet group 23a to the third front magnet group 23c on the plane perpendicular to the optical axis.

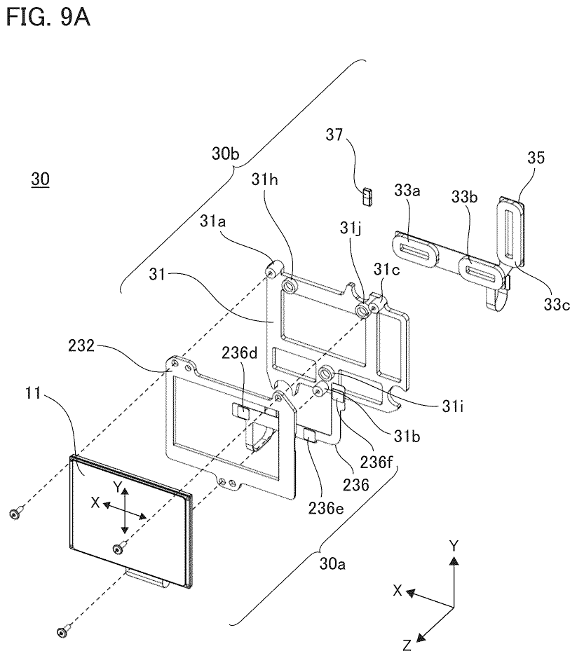

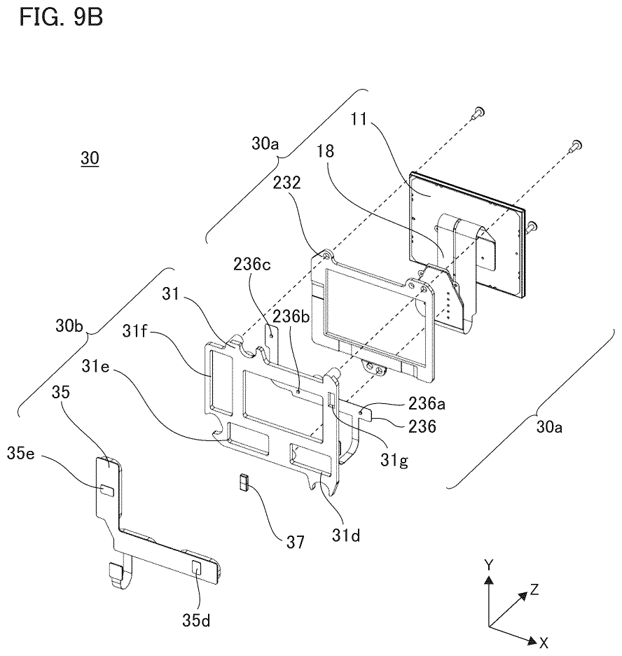

FIG. 9A is an exploded perspective view of the movable part 30 of the first image blur correction unit 40, and FIG. 9B is an exploded perspective view of the movable part 30 of the first image blur correction unit 40 viewed from a direction different from that in FIG. 9A.

The drive FPC 35 is disposed so as to overlap the first coil 33a, the second coil 33b, and the third coil 33c on the XY projection plane, and is fixed to the first movable member 31 by adhesive or the like.

The first coil 33a, the second coil 33b, and the third coil 33c are electrically connected to the drive FPC 35, and the first blur correction control unit 15a controls the current flowing to each coil via the drive FPC 35.

Note that, in the Second Embodiment, as described below, detection elements are disposed on a detection FPC 236, and unlike the First Embodiment, the detection element is not disposed in the drive FPC 35. The detection FPC 236 is disposed on the surface on the −Z side of a second movable member 232 and is fixed to the second movable member 232 by adhesive or the like.

The detection FPC 236 has a first detection element 236a, a second detection element 236b, and a third detection element 236c mounted thereon. The first detection element 236a, the second detection element 236b, and the third detection element 236c function as position detection units for detecting a position of the first movable member 31, and in the present embodiment are disposed on the second movable member 232. Note that the position detection unit may be disposed on the imaging element 11 side.

The first detection element 236a is disposed at a position facing the first opening 221a, the second detection element 236b is disposed at a position facing the second opening 221b, and the third detection element 236c is disposed at a position facing the third opening 221c. That is, the first opening 221a to the third opening 221c of the base plate 221 serving as the fixing member are provided at positions facing the first detection element 236a to the third detection element 236c each serving as the position detection unit.

The first detection element 236a, the second detection element 236b, and the third detection element 236c are, for example, Hall elements. A first detection yoke 236d is disposed on a side opposite to the first detection element 236a of the detection FPC 236, a second detection yoke 236e is disposed on a side opposite to the second detection element 236b, and a third detection yoke 236f is disposed on a side opposite to the third detection element 236c.

The first detection yoke 236d, the second detection yoke 236e, and the third detection yoke 236f are each formed of a magnetic material and are fixed to the detection FPC 236 by adhesive or the like.

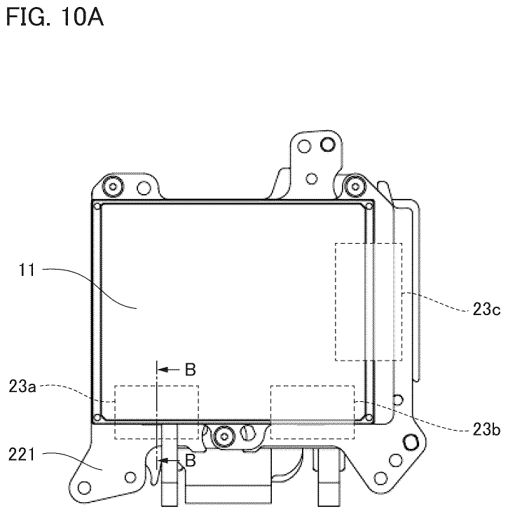

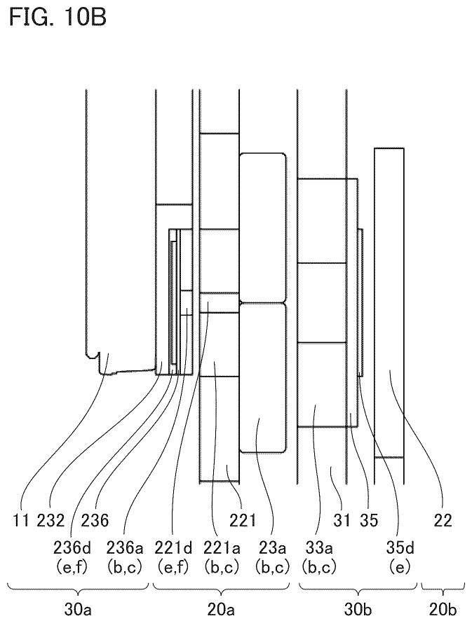

FIG. 10A is a front view of the first blur correction unit 40 according to the Second Embodiment, and FIG. 10B is a cross-sectional view of the first image blur correction unit 40 according to the Second Embodiment Second Embodiment taken along line B-B. As shown in FIG. 10B, the imaging element 11, the second movable member 232, the first detection yoke 236d, the first detection element 236a, the base plate 221, the first front magnet group 23a, the first coil 33a, and the rear yoke 22 are disposed in order from the +Z direction.

That is, the first front magnet group 23a is disposed between the first coil 33a and the first detection element 236a serving as a position detection unit in the optical axis direction (Z direction).

As described above, the base plate 221 has the first opening 23a at a position facing the first front magnet group 221a. Therefore, the first front magnet group 23a forms a fifth magnet circuit passing through the first opening 221a and the first detection yoke 236d. The first detection element 236a detects magnetic forces of the fifth magnetic circuit.

Here, the first detection yoke 236d is disposed on the side closer to the first front magnet group 23a than the imaging element 11 in the Z direction. Therefore, the first detection yoke 236d serves a role of suppressing a magnetic field from the first front magnet group 23a that has passed through the first opening 221a from entering the image capturing element 11 and becoming noise in the image capturing signal.

Additionally, the first beam part 221d serves a role of widening a range in which the magnetic flux density linearly changes in the range in which the first detection element 236a can detect the magnetic flux density of the fifth magnetic circuit. Note that although, in the present embodiment, the first beam part 221d is formed integrally with the base plate 221, a configuration in which a separate component made of a magnetic material is attached to the first opening 221a of the base plate 221 may be adopted. Additionally, the first beam part 221d may be omitted.

Similarly, the second front magnet group 23b forms the sixth magnetic circuit that passes through the second detection yoke 236e, and the third front magnet group 23c forms the seventh magnetic circuit that passes through the third detection yoke 236f. The second detection element 236b detects the magnetic force of the sixth magnetic circuit, and the third detection element 236c detects the magnetic force of the seventh magnetic circuit.

The first blur correction control unit 15a calculates position information of the movable part 30 with respect to the fixed part 20 in the XY plane (specifically, position and angle around the optical axis) based on detection results of magnetic force by the first detection element 236a, the second detection element 236b, and the third detection element 236c.

The first blur correction control unit 15a calculates a deviation between a movement target value of the imaging element 11 based on blur information detected by the first vibration detection unit 16a and a current position of the imaging element 11 calculated from the first detection element 236a to the third detection element 236c. The driving of the movable part 30 is then controlled by feedback control based on this deviation.

Here, in a case in which the detection element is disposed inside a coil as in the First Embodiment, there is a possibility that the magnetic force generated from the coil when the coil is energized enters the detection element. Therefore, there is a possibility that an error occurs in the position information of the movable part 30 calculated by the first blur correction control unit 15a from the magnetic force detected by the detection element.

However, by disposing the detection element on a side opposite to the coil with the magnet interposed therebetween in the Z direction as in the Second Embodiment, magnetic force generated from the coil that enters the detection element can be reduced.

Note that, in the First Embodiment, an attractive force toward the base plate 21 in the +Z direction is generated on the first movable member 31 by the first biasing part, the second biasing part, and the third biasing part. In contrast, an attractive force toward the base plate 21 in the −Z direction is generated on the second movable member 232 by the fifth magnetic circuit, the sixth magnetic circuit, and the seventh magnetic circuit.

Here, the sizes of the first thrust metal plate 35d, the second thrust metal plate 35e, the thrust yoke 38, the first detection yoke 236d, the second detection yoke 236e, and the third detection yoke 236f are set as follows.

That is, a force for attracting the first movable member 31 to the base plate 21 is set to be larger than a force for suctioning the second movable member 232 to the base plate 21. Therefore, the first movable member 31 is biased in the +Z direction toward the base plate 21.

As a result, in a similar manner to the First Embodiment, the size of the rear yoke 22 within the XY plane can be reduced. Additionally, by setting a pull-out direction of the drive FPC 35 in a direction opposite to the rear yoke 22 in the XY plane, it becomes possible to suppress an increase in size of the first blur correction unit 40 in the Z direction.

Hereinafter, the first blur correction unit 40 of the Third Embodiment, which is a variation of the First Embodiment, will be explained.

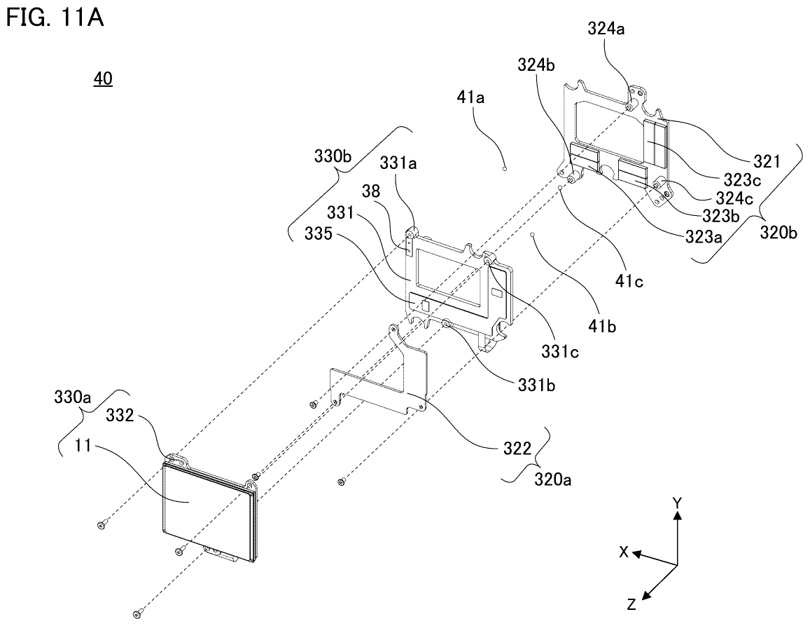

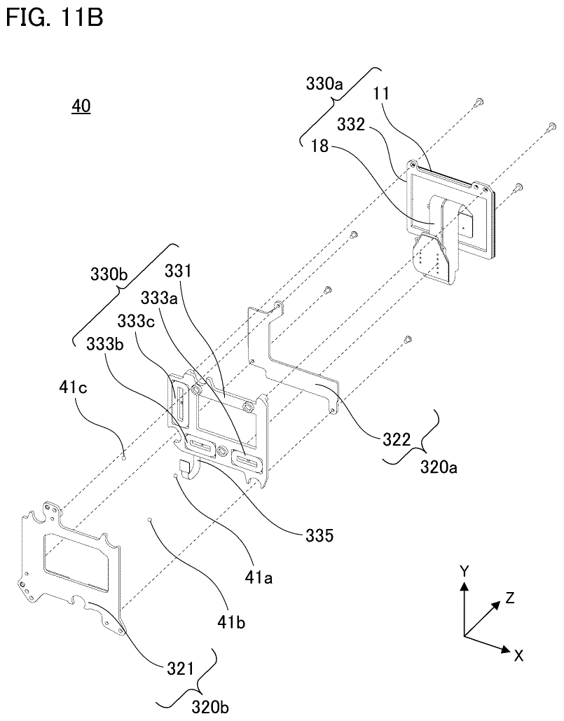

FIG. 11A is an exploded perspective view of the first blur correction unit 40 provided in the imaging apparatus according to the Third Embodiment, and FIG. 11B is an exploded perspective view of the first blur correction unit 40 viewed from a direction different from that in FIG. 11A.

The first blur correction unit 40 according to the Third Embodiment is configured by a fixing part 320, a movable part 330, and balls 41a to 41c, and so on. The fixing part 320 is configured by a front fixing part 320a and a rear fixing part 320b and so on. The movable part 330 is configured by a front movable part 330a and a rear movable part 330b and so on.

In the first blur correction unit 40 according to the Third Embodiment, the front movable part 330a, the front fixing part 320a, the rear movable part 330b, and the rear fixing part 320b are disposed in order of proximity to the mount member 13a on the body side in the Z direction.

The front fixing part 320a has a front York 322. The rear movable part 330b has a base plate 321, a first rear magnet group 323a, a second rear magnet group 323b, a third rear magnet group 323c. Here, the base plate 321 functions as a fixing member disposed inside the main body 10a of the imaging apparatus.

Each of the first front magnet group 323a, the second front magnet group 323b, and the third front magnet group 323c is held by being fixed to the base plate 321 that serves as a fixing member using an adhesive and the like. Additionally, the base plate 321 that serves as a fixing member is formed of magnetic material.

The fixing part 320 also includes a first support column member 324a, a second support column member 324b, and a third support column member 324c. The front yoke 322 of the front fixing part 320a is fixed to the base plate 321 of the rear fixing part 320b via the first support column member 324a, the second support column member 324b, and the third support column member 324c by screws and the like.

Additionally, the first support column member 324a, the second support column member 324b, and the third support column member 324c restrict movement of the movable part 330 in the XY plane within a predetermined range.

The front yoke 322 and the base plate 321 are disposed such that the first rear magnet group 323a, the second rear magnet group 323b, and the third rear magnet group 323c are interposed therebetween in the Z direction.

The first rear magnet group 323a forms a first magnetic circuit passing through the front yoke 322 and the base plate 321. Similarly, the second rear magnet group 323b and the third rear magnet group 323c form a second magnetic circuit and a third magnetic circuit.

The movable part 330 is configured by a front movable part 330a and a rear movable part 330b and so on. The front movable part 330a includes the imaging element 11, the imaging FPC 18, and a second movable member 332, and the imaging element 11 is fixed to the second movable member 332 by adhesive and the like.

The rear movable part 330b includes a first movable member 331, a first coil 333a, a second coil 333b, a third coil 333c, a drive FPC 335, a thrust magnet 37 (not illustrated), and a thrust yoke 38. The first movable member 331 includes a fourth support part 331a, a fifth support part 331b, and a sixth support part 331c.

The first movable member 331 holds the imaging element 11 and is movable relative to the direction orthogonal to the optical axis of the imaging element with respect to the base plate 321 that serves as a fixing member. Additionally, the first coil 333a is held by the first movable member 331 and is disposed at a position facing the first front magnet group 323a, the second coil 333b is held by the first movable member 331 and is disposed at a position facing the second front magnet group 323b, and the third coil 333c is held by the first movable member 331 and is disposed at a position facing the third front magnet group 323c.

The second movable member 332 of the front movable part 330a is fixed to the fourth support part 331a, the fifth support part 331b, and the sixth support part 331c that are formed on the first movable member 331 of the rear movable part 330b using screws and the like. That is, the second movable member 332 holds the imaging element 11 and is fixed to the first movable member 331.

Hereinafter, the first blur correction unit 40 of the Fourth Embodiment, which is one of variations of the First Embodiment, will be explained.

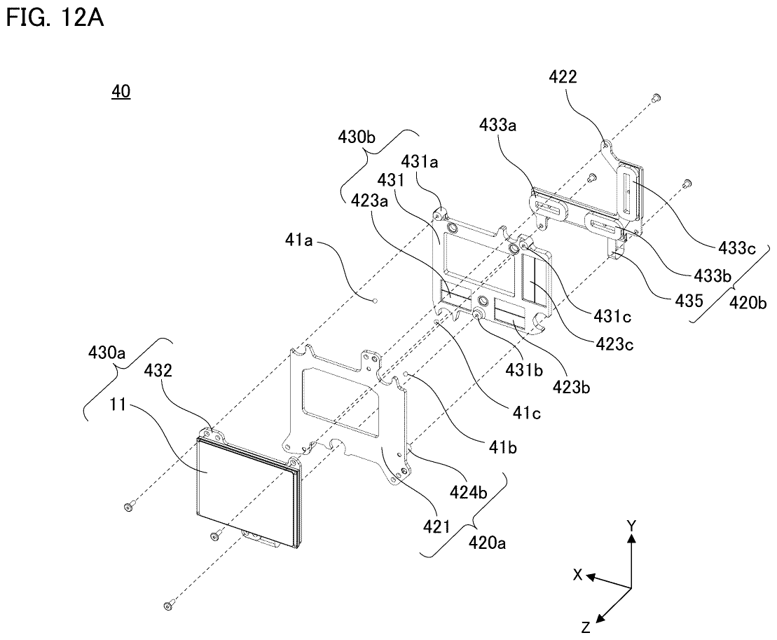

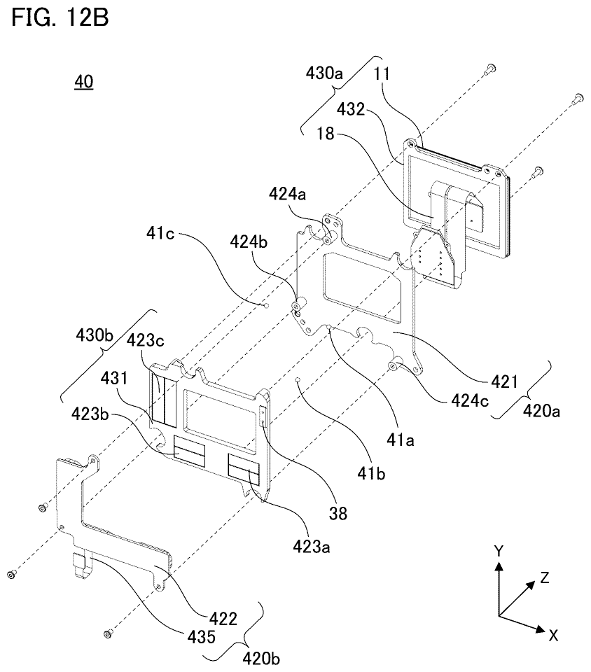

FIG. 12A is an exploded perspective view of the first blur correction unit 40 provided in the imaging apparatus according to the Fourth Embodiment and FIG. 12B is an exploded perspective view of the first blur correction unit 40 viewed from a direction different from that in FIG. 12A.

The first blur correction unit 40 according to the Fourth Embodiment is configured by a fixing part 420, a movable part 430, and balls 41a to 41c, and so on. The fixing part 420 is configured by a front fixing part 420a and a rear fixing part 420b and so on. The movable part 430 is configured by a front movable part 430a and a rear movable part 430b and so on.

In the first blur correction unit 40 according to the Fourth Embodiment, the front movable part 430a, the front fixing part 420a, the rear movable part 430b, and the rear fixing part 420b are disposed in order of proximity to the mount member 13a on the body side in the Z direction.

The front fixing part 420a has a base plate 421. Here, the base plate 421 functions as a fixing member disposed inside the main body 10a of the imaging apparatus. Additionally, the base plate 421 is formed of magnetic material.

The rear fixing part 420b has a rear yoke 422, a first coil 433a, a second coil 433b, a third coil 433c, and a drive FPC 35. Additionally, the first coil 433a is held by the rear yoke 422 and is disposed at a position facing the first magnet group 423a, the second coil 433b is held by rear yoke 422 and is disposed at a position facing the second magnet group 423b, and the third coil 433c is held by the rear yoke 422 and is disposed at a position facing the third front magnet group 423c.

The fixing part 420 also includes a first support column member 424a, a second support column member 424b, and a third support column member 424c. The rear yoke 422 of the rear fixing part 420b is fixed to the base plate 421 of the front fixing part 420b via the first support column member 424a, the second support column member 424b, and the third support column member 424c by screws and the like.

Additionally, the first support column member 424a, the second support column member 424b, and the third support column member 424c restrict movement of the movable part 430 in the XY plane within a predetermined range.

The movable part 430 is configured by a front movable part 430a and a rear movable part 430b and so on. The front movable part 430a includes the imaging element 11, the imaging FPC 18, and a second movable member 432, and the imaging element 11 is fixed to the second movable member 432 by adhesive and the like.

The rear movable part 430b includes a first movable member 431, a first magnet group 423a, a second magnet group 423b, a third magnet group 423c, a thrust magnet 37 (not illustrated), and a thrust yoke 38. The first movable member 431 includes a fourth support part 431a, a fifth support part 431b, and a sixth support part 431c.

The first movable member 431 holds the imaging element 11 and is movable relative to the direction orthogonal to the optical axis of the imaging element with respect to the base plate 421 that serves as a fixing member. Additionally, the first rear magnet group 323a, the second rear magnet group 323b, and the third rear magnet group 323c are respectively held by the first movable member 431 as a fixing member by adhesive or the like.

The base plate 421 of the front fixing part 420a and the front yoke 422 of the rear fixing part 420b are disposed such that the first magnet group 423a, the second magnet group 423b, and the third magnet group 423c are interposed therebetween in the Z direction.

The first magnet group 423a forms a first magnetic circuit passing through the base plate 421 and the rear yoke 422. Similarly, the second magnet group 423b and the third magnet group 423c respectively form a second magnetic circuit and a third magnetic circuit.

The second movable member 432 of the front movable part 430a is fixed to the fourth support part 431a, the fifth support part 431b, and the sixth support part 431c that are formed on the first movable member 431 of the rear movable part 430b using screws and the like. That is, the second movable member 432 holds the imaging element 11 and is fixed to the first movable member 431.

Hereinafter, the first blur correction unit 40 of the Fifth Embodiment, which is one of variations of the First Embodiment, will be explained.

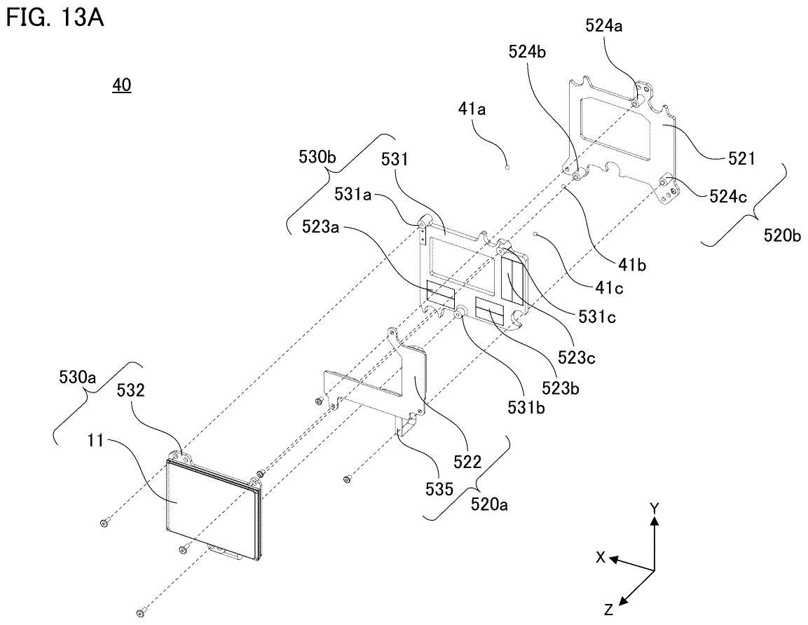

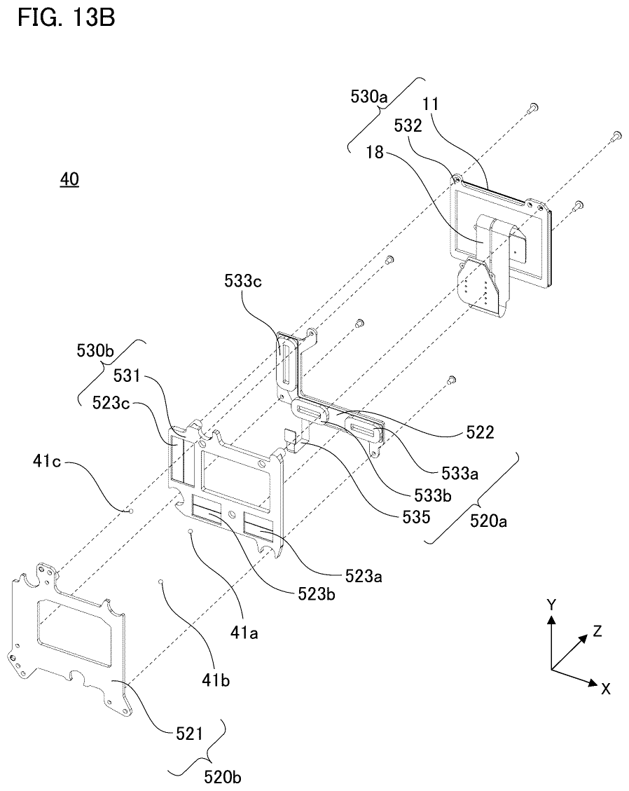

FIG. 13A is an exploded perspective view of the first blur correction unit 40 provided in the imaging apparatus according to the Fifth Embodiment and FIG. 13B is an exploded perspective view of the first blur correction unit 40 viewed from a direction different from that in FIG. 13A.

The first blur correction unit 40 according to the Fifth Embodiment is configured by a fixing part 520, a movable part 530, and balls 41a to 41c, and so on. The fixing part 520 is configured by a front fixing part 520a and a rear fixing part 520b and so on. The movable part 530 is configured by a front movable part 530a and a rear movable part 530b and so on.

In the first blur correction unit 40 according to the Fifth Embodiment, the front movable part 530a, the front fixing part 520a, the rear movable part 530b, and the rear fixing part 520b are disposed in order of proximity to the mount member 13a on the body side in the Z direction.

The front fixing part 520a has a front yoke 522, a first coil 533a, a second coil 533b, and a third coil 533c. The rear fixing part 520b has a base plate 521. Here, the base plate 521 functions as a fixing member disposed inside the main body 10a of the imaging apparatus. Additionally, the base plate 521 is formed of magnetic material.

The front fixing part 520a has a front yoke 522, a first coil 533a, a second coil 533b, a third coil 533c, and a drive FPC 535. Additionally, the first coil 533a is held by the front yoke 522 and is disposed at a position facing the first magnet group 523a, the second coil 533b is held by front yoke 522 and is disposed at a position facing the second magnet group 523b, and the third coil 533c is held by the front yoke 522 and is disposed at a position facing the third front magnet group 523c.

The fixing part 520 also includes a first support column member 524a, a second support column member 524b, and a third support column member 524c. The front yoke 522 of the front fixing part 520a is fixed to the base plate 521 of the rear fixing part 520b via the first support column member 524a, the second support column member 524b, and the third support column member 524c by screws and the like.

Additionally, the first support column member 524a, the second support column member 524b, and the third support column member 524c restrict movement of the movable part 530 in the XY plane within a predetermined range.

The movable part 530 is configured by a front movable part 530a and a rear movable part 530b and so on. The front movable part 530a includes the imaging element 11, the imaging FPC 18, and a second movable member 532, and the imaging element 11 is fixed to the second movable member 532 by adhesive and the like.

The rear movable part 530b includes a first movable member 531, a first magnet group 523a, a second magnet group 523b, a third magnet group 523c, a thrust magnet 37 (not illustrated), and a thrust yoke 38. The first movable member 531 includes a fourth support part 531a, a fifth support part 531b, and a sixth support part 531c.

The first movable member 531 holds the imaging element 11 and is movable relative to the direction orthogonal to the optical axis of the imaging element with respect to the base plate 521 that serves as a fixing member. Additionally, the first magnet group 523a, the second magnet group 523b, and the third magnet group 523c are respectively held by the first movable member 531 as a fixing member by adhesive or the like.

The front yoke 522 of the front fixing part 520a and the base plate 521of the rear fixing part 520b are disposed such that the first magnet group 523a, the second magnet group 523b, and the third magnet group 523c are interposed therebetween in the Z direction.

The first magnet group 523a forms a first magnetic circuit passing through the rear yoke 522 and the base plate 521. Similarly, the second magnet group 523b and the third magnet group 523c respectively form a second magnetic circuit and a third magnetic circuit.

The second movable member 532 of the front movable part 530a is fixed to the fourth support part 531a, the fifth support part 531b, and the sixth support part 531c that are formed on the first movable member 531 of the rear movable part 530b using screws and the like. That is, the second movable member 532 holds the imaging element 11 and is fixed to the first movable member 531.[0189] While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the imaging apparatus and the like through a network or various storage media. Then, a computer (or a CPU, an MPU, or the like) of the imaging apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-068178, filed on Apr. 19, 2024 and Japanese Patent Application No. 2025-059093, filed on Mar. 31, 2025, which are hereby incorporated by reference herein in its entirety.

What is claimed is:

1. An imaging apparatus comprising:
a fixing member disposed on a main body of the imaging apparatus;
a magnet held by the fixing member;
an imaging element;
a first movable member that holds the imaging element and is movable with respect to the fixing member in a direction orthogonal to an optical axis of the imaging element; and
a coil that is held by the first movable member and is disposed at a position facing the magnet,
wherein a part of the fixing member is disposed at a position interposed between the imaging element and the first movable member in a direction of the optical axis, and
wherein a part of the coil is disposed so as to overlap with the imaging element on a projection plane perpendicular to the optical axis.

2. The imaging apparatus according to claim 1,
wherein the magnet is disposed at a position interposed between the imaging element and the first movable member in a direction of the optical axis, and
wherein a part of the magnet is disposed so as to overlap with the imaging element on the projection surface.

3. The imaging apparatus according to claim 1, wherein the fixing member is formed of a magnetic material.

4. The imaging apparatus according to claim 1, further comprising a yoke member that is held by the first movable member and is disposed at a position facing the magnet, and
wherein a magnetic force of the yoke member and the magnet biases the first movable member in a direction approaching the fixing member.

5. The imaging apparatus according to claim 1, further comprising a plurality of rolling members disposed so as to be brought into contact with the first movable member and the fixing member,
wherein at least a part of the rolling members is disposed so as to overlap with the imaging element on the projection plane.

6. The imaging apparatus according to claim 1, wherein a part of the coil is disposed so as to overlap with the imaging element on the projection plane.

7. The imaging apparatus according to claim 1, further comprising a second movable member that holds the imaging element and is fixed to the first movable member, and
wherein a linear expansion coefficient of the second movable member is larger than a linear expansion coefficient of the first movable member.

8. The imaging apparatus according to claim 7, further comprising a position detection unit configured to detect a position of the first movable member,
wherein the position detection unit is disposed on the imaging element or the second movable member, and
wherein the magnet is disposed between the coil and the position detection unit in the direction of the optical axis.

9. The imaging apparatus according to claim 8, wherein the fixing member is formed of magnetic material and has an opening at a position facing the position detection unit.

10. The imaging apparatus according to claim 9, wherein the opening is larger than a moving amount of the first movable member in a direction orthogonal to the optical axis.

11. The imaging apparatus according to claim 9, wherein the opening has a beam part at a position coinciding with a boundary surface between the N pole and the S pole of the magnet on a plane perpendicular to the optical axis.
